(19) United States
(12) Patent Application Publication
(10) Pub. No.: US 2026/0074997 A1
(43) Pub. Date: Mar. 12, 2026

(54) CONGESTION-AWARE DEVICE UPLINK RATE ADAPTATION

(71) Applicant: Dell Products L.P., Round Rock, TX (US)

(72) Inventor: Ali Esswie, Calgary (CA)

(21) Appl. No.: 18/827,110

(22) Filed: Sep. 6, 2024

(51) Int. Cl. H04W 28/02; H04L 47/263; H04L 47/28

(52) U.S. Cl. CPC H04L 47/12; H04L 47/129; H04L 47/24; H04L 47/2425; H04L 47/263; H04L 47/28; H04W 28/0252; H04W 28/0268

(57) ABSTRACT

A radio network node sets up a bearer with a user equipment to facilitate a communication session associated. The node may determine that radio link congestion prohibits delivering session traffic according to a particular quality-of-service via the bearer, and may indicate, to the user equipment, the congestion, or congestion effects, in a bearer congestion report. If a subscription associated with the user equipment does not enable the particular quality-of-service being guaranteed, the user equipment may determine, based on the congestion indicated by the node, a reduced processing quality to apply to transmitting buffered uplink traffic to the node and may report to the node a changed modulation/coding scheme to be used to transmit the buffered traffic. If a subscription associated with the user equipment guarantees the particular quality-of-service, the node may switch to a higher quality/priority bearer to facilitate transmission of buffered uplink traffic according to the particular quality-of-service.

### REFERENCE TO RELATED APPLICATIONS

The subject patent application is related to U.S. Patent Application No. ------, filed, ------, and entitled “ADAPTIVE BEARER CONGESTION SIGNALING” (docket no. 139812.01/DELLP1333US), the entirety of which application is hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise determining, by a radio network node comprising at least one processor from at least one user equipment, a congestion corresponding to at least one bearer corresponding to at least one user equipment to result in at least one determined congestion. The method may further comprise facilitating, by the radio network node, transmitting, to the at least one user equipment, at least one bearer congestion report indicative of at least one congestion management indication corresponding to the at least one determined congestion and facilitating at least one traffic delivery operation, with respect to the at least one user equipment, that is based on the at least one determined congestion.

The at least one congestion management indication may be indicative of at least one of: at least one delay metric corresponding to the at least one bearer or at least one data rate corresponding to the at least one bearer. The at least one congestion management indication may be usable by the at least one user equipment to select at least one processing quality, for example an encoder/decoder (“CODEC”) to apply to traffic corresponding to at least one traffic flow being delivered via the at least one bearer.

In an example embodiment, the at least one congestion management indication may comprise at least one bearer quality switching indication indicative that a first quality corresponding to the at least one bearer is to be changed, by the radio network node, to a second quality corresponding to the at least one bearer, and wherein, based on the at least one determined congestion, the second quality is capable of facilitating delivery of uplink traffic from the at least one user equipment to the radio network node according to a quality-of-service associated with at least one traffic flow being facilitated by the at least one bearer. The quality-of-service associated with at least one traffic flow may be based on, or guaranteed by, a subscription corresponding to the at least one user equipment.

In an example embodiment, the method may further comprise changing, by the radio network node, at least one traffic delivery parameter associated with the at least one bearer to result in a changed bearer, wherein the changed bearer is capable, based on the at least one determined congestion, of facilitating delivery of the uplink traffic from the at least one user equipment to the radio network node according to the quality-of-service associated with at least one traffic flow.

The at least one traffic delivery parameter may comprise at least one modulation scheme or at least one coding scheme.

In an example embodiment, the method may further comprise facilitating, by the radio network node, receiving, from core network equipment, adaptive bearer switching configuration information indicative that delivery of the at least one traffic flow is to be accommodated, based on the at least one determined congestion, according to the quality-of-service associated with at least one traffic flow.

The adaptive bearer switching configuration information may be received during connection establishment between the at least one user equipment and the radio network node.

In an example embodiment, the determining the at least one determined congestion may comprise, for each of the at least one bearer, determining at least one congestion parameter value to result in at least one determined congestion parameter value, and analyzing the at least one determined congestion parameter value with respect to at least one congestion parameter criterion to result in at least one analyzed determined congestion parameter value. The at least one determined congestion may be determined to be the at least one analyzed determined congestion parameter value based on the at least one analyzed determined congestion parameter value being determined to fail to satisfy the at least one congestion parameter criterion. The at least one congestion parameter criterion may comprise at least one congestion determining period. The at least one analyzed determined congestion parameter value being determined to fail to satisfy the at least one congestion parameter criterion may comprise determining that the at least one determined congestion parameter value corresponds to increasing congestion monotonically during the at least one congestion determining period. The at least one congestion determining period may be a configured period.

In another example embodiment, a radio network node, may comprise at least one processor configured to process executable instructions that, when executed by the at least one processor, facilitate performance of operations that may comprise receiving, from core network equipment, adaptive bearer switching configuration information indicative that delivery of at least one traffic flow corresponding to at least one user equipment is to be facilitated by the radio network node via at least one bearer based on at least one determined congestion corresponding to at least one communication link between the radio network node and the at least one user equipment. The operations may further comprise transmitting, to the at least one user equipment, at least one bearer congestion report indicative of at least one congestion management indication corresponding to the at least one determined congestion, and performing at least one traffic delivery operation, with respect to the at least one user equipment, that is based on the at least one determined congestion.

The at least one congestion management indication may be usable by the at least one user equipment to select at least one CODEC to apply to traffic corresponding to the at least one traffic flow.

The at least one congestion management indication may comprise at least one bearer quality switching indication indicative that a first quality corresponding to the at least one bearer is to be changed, by the radio network node, to a second quality corresponding to the at least one bearer, and wherein, based on the at least one determined congestion, the second quality is capable of facilitating delivery of traffic from the at least one user equipment to the radio network node according to a quality-of-service associated with the at least one traffic flow.

In an example embodiment, the operations may further comprise changing at least one traffic delivery parameter associated with the at least one bearer to result in a changed bearer, wherein the changed bearer is capable, based on the at least one determined congestion, of facilitating delivery of the traffic from the at least one user equipment to the radio network node according to the quality-of-service associated with the at least one traffic flow. The at least one traffic delivery parameter may comprise at least one of: at least one modulation scheme or at least one coding scheme.

In yet another example embodiment, a non-transitory machine-readable medium may comprise executable instructions that, when executed by at least one processor of radio network equipment, facilitate performance of operations that may comprise receiving, from core network equipment, adaptive bearer switching configuration information indicative that delivery of at least one traffic flow via at least one established connection with at least one user equipment is to be facilitated by at least one bearer based on at least one determined congestion. With respect to the at least one bearer, the operations may comprise determining at least one congestion parameter value to result in at least one determined congestion parameter value and analyzing the at least one determined congestion parameter value with respect to at least one congestion parameter criterion to result in at least one analyzed determined congestion parameter value. The at least one analyzed determined congestion parameter value may be determined to be the at least one determined congestion based on the at least one analyzed determined congestion parameter value being determined to fail to satisfy the at least one congestion parameter criterion. The operations may further comprise transmitting, to the at least one user equipment, at least one bearer congestion report indicative of at least one congestion management indication corresponding to the at least one determined congestion. The operations may comprise performing, or initiating, at least one traffic delivery operation, with respect to the at least one user equipment, that is based on the at least one determined congestion. A traffic delivery operation may comprise changing a bearer quality or priority based on the at least one determined congestion to accommodate a guaranteed quality-of-service associated with a subscription associated with the user equipment. The subscription may be used to establish the at least one established communication session.

The at least one congestion parameter criterion may comprise at least one congestion determining period. The at least one analyzed determined congestion parameter value being determined to fail to satisfy the at least one congestion parameter criterion comprises determining that the at least one determined congestion parameter value corresponds to monotonically increasing congestion corresponding to the at least one bearer during the at least one congestion determining period.

The at least one congestion management indication may be usable by the at least one user equipment to select at least one CODEC to apply to traffic corresponding to the at least one traffic flow.

In an example embodiment, the at least one congestion management indication may comprise at least one bearer quality switching indication indicative that a first quality corresponding to the at least one bearer is to be changed, by the radio network equipment, to a second quality corresponding to the at least one bearer. Based on the at least one determined congestion, the second quality may be capable of facilitating delivery of uplink traffic received by the radio network equipment from the at least one user equipment according to a quality-of-service associated with the at least one traffic flow. The operations may further comprise changing, by the radio network equipment, at least one traffic delivery parameter associated with the at least one bearer to result in a changed bearer. The changed bearer may be capable, based on, or with respect to, the at least one determined congestion, of facilitating delivery of the uplink traffic from the at least one user equipment to the radio network equipment according to the quality-of-service associated with at least one traffic flow.

In an example embodiment, a method may comprise receiving, by at least one user equipment comprising at least one processor from a radio network node, at least one bearer congestion report indicative of at least one congestion management indication corresponding to at least one determined congestion corresponding to at least one bearer being used by the at least one user equipment to communicate traffic with the radio network node. Responsive to the at least one bearer congestion report, the method may further comprise communicating traffic with respect to the radio network node based on the at least one congestion management indication. The at least one congestion management indication may be indicative of at least one of: at least one delay corresponding to the at least one bearer or at least one data rate corresponding to the at least one bearer.

In an example embodiment, the at least one congestion management indication may be further indicative of at least one bearer quality switching indication indicative that a first quality, or a first priority, corresponding to the at least one bearer is to be changed, by the radio network node, to a second quality, or a second priority, corresponding to the at least one bearer. Based on the at least one determined congestion, the second quality, or second priority, may be capable of facilitating delivery of uplink traffic from the at least one user equipment to the radio network node according to a quality-of-service associated with at least one traffic flow being facilitated by the at least one bearer.

In an example embodiment, the method may further comprise avoiding, by the at least one user equipment, determining, based on the at least one congestion management indication, at least one processing quality to apply to traffic corresponding to the at least one traffic flow. The user equipment made determine to avoid determining a processing quality, or CODEC, to apply to the traffic based on a VIP subscription, which may guarantee a quality of service associated with the traffic flow, being used to facilitate delivery of traffic corresponding to the at least one traffic flow.

In an example embodiment, the at least one congestion management indication may be a first congestion management indication. The first congestion management indication may be indicative of at least one of: at least one delay corresponding to the at least one bearer or at least one data rate corresponding to the at least one bearer. The method may further comprise training, with the at least one delay or the at least one data rate, at least one learning model to result in at least one trained learning model. The at least one trained learning model may be usable by the at least one user equipment to, based on a second congestion management indication, determine at least one processing quality to apply to traffic corresponding to the at least one traffic flow being delivered via the at least one bearer.

In an example embodiment, based on the at least one congestion management indication, the method may further comprise determining, by the at least one user equipment, at least one processing quality to apply to traffic corresponding to at least one traffic flow being delivered via the at least one bearer. The at least one processing quality may correspond to at least one CODEC.

In an example embodiment, the at least one traffic flow being delivered via the at least one bearer may be delivered according to a first CODEC. The at least one CODEC that corresponds to the at least one processing quality determined by the user equipment may be a second CODEC. The method may further delivering, by the at least one user equipment to the radio network node, the at least one traffic flow via the at least one bearer according to the second CODEC.

In an example embodiment, the determining of the at least one processing quality to apply to the traffic corresponding to the at least one traffic flow may comprise analyzing, with respect to at least one delay specification corresponding to the second CODEC or at least one data rate specification corresponding to the second CODEC, at least one of at least one delay associated with the at least one traffic flow or at least one data rate associated with the at least one traffic flow. Thus, a user equipment may select the second CODEC such that the delay or date rate caused by the congestion indicated in a bearer congestion report received from the radio network node can be facilitated by the current bearer being used for delivery of traffic corresponding to the at least one traffic flow.

In an example embodiment, the method may further comprise determining, by the at least one user equipment, at least one modulation scheme or at least one coding scheme that is capable of facilitating transmitting, by the at last one user equipment to the radio network node, the traffic according to the second CODEC to result in at least one determined modulation scheme or at least one determined coding scheme.

In an example embodiment, the method may further comprise transmitting, by the at least one user equipment to the radio network node, at least one modulation and coding scheme report indicative of the at least one determined modulation scheme or the at least one determined coding scheme, wherein the at least one determined modulation scheme or the at least one determined coding scheme is to be usable by the radio network node to decode the traffic.

In another example embodiment, a user equipment may comprise at least one processor configured to process executable instructions that, when executed by the at least one processor, may facilitate performance of operations that may comprise receiving, from a radio network node, a bearer congestion report indicative of at least one determined congestion, determined by the radio network node, corresponding to a bearer being used by the user equipment to transmit traffic, associated with a traffic flow, to the radio network node. Based on the at least one determined congestion, the operations may further comprise transmitting the traffic to the radio network node.

In an example embodiment, based on the at least one determined congestion, the operations may further comprise determining at least one processing quality to apply to transmission of the traffic, via the bearer, to result in at least one determined processing quality. Responsive to the bearer congestion report, the operations may further comprise transmitting the traffic to the radio network node according to the at least one determined processing quality. The at least one processing quality may correspond to at least one CODEC. Before the receiving of the bearer congestion report, the traffic flow may be delivered according to a first CODEC. The at least one CODEC that corresponds to the at least one determined processing quality may be a second CODEC. The transmitting the traffic according to the at least one determined processing quality may comprise transmitting the traffic according to the second CODEC.

In an example embodiment, the operations may further comprise transmitting, to the radio network node, at least one modulation and coding scheme report indicative of at least one modulation scheme or at least one coding scheme to be usable by the radio network node to decode the traffic transmitted according to the second CODEC.

In yet another example embodiment, a non-transitory machine-readable medium may comprise executable instructions that, when executed by at least one processor of a user device, facilitate performance of operations that may comprise receiving, from at least one radio network equipment component, a bearer congestion report indicative of at least one congestion indication corresponding to at least one determined congestion, determined by the at least one radio network equipment component, and corresponding to a bearer being used by the user device to transmit traffic, associated with a traffic flow, to the at least one radio network equipment component. Based on the at least one congestion indication, the operations may further comprise transmitting the traffic to the at least one radio network equipment component.

The at least one congestion indication may be indicative of at least one bearer quality switching indication indicative that a first quality corresponding to the bearer is to be changed, by the at least one radio network equipment component, to a second quality corresponding to the bearer, wherein, based on the at least one determined congestion, the second quality may be capable of facilitating delivery of uplink traffic from the user device to the at least one radio network equipment component according to a quality-of-service associated with the traffic flow being facilitated by the bearer.

In an example embodiment, based on the at least one congestion indication, the operations may further comprise determining at least one encoder and decoder (CODEC) to apply to the transmitting the traffic, via the bearer, to result in at least one determined CODEC, wherein the transmitting of the traffic to the at least one radio network equipment component comprises transmitting the traffic according to the at least one determined CODEC.

In an example embodiment, operations may further comprise transmitting, to the at least one radio network equipment component, at least one modulation and coding scheme report indicative of at least one modulation scheme or at least one coding scheme to be usable by the at least one radio network equipment component to decode the traffic transmitted according to the at least one determined CODEC.

### BRIEF DESCRIPTION OF THE DRAWINGS

FIG. 1 illustrates wireless communication system environment.

FIG. 2 illustrates an example virtual reality appliance.

FIG. 3 illustrates an example environment with multiple extended reality appliances tethered to an extended reality intermediate processing unit.

FIG. 4 illustrates example adaptive bearer switching configuration information.

FIG. 5 illustrates example bearer congestion report information.

FIG. 6 illustrates example modulation and coding scheme report information.

FIG. 7 illustrates a timing diagram of an example embodiment of a radio network node facilitating delivery of traffic with a user equipment based on bearer congestion report information transmitted to the user equipment.

FIG. 8 illustrates a timing diagram of a user equipment determining traffic delivery parameters to apply to delivery of traffic to a radio network node based on bearer congestion report information received from the radio network node.

FIG. 9 illustrates a flow diagram of an example embodiment method using a user equipment determining coding, decoding, modulation schemes, or coding schemes to be used to deliver uplink traffic based on bearer congestion report information received from a radio network node.

FIG. 10 illustrates a block diagram of an example method embodiment.

FIG. 11 illustrates a block diagram of an example radio network node.

FIG. 12 illustrates a block diagram of an example non-transitory machine-readable medium embodiment.

FIG. 13 illustrates a block diagram of an example method embodiment.

FIG. 14 illustrates a block diagram of an example user equipment.

FIG. 15 illustrates a block diagram of an example non-transitory machine-readable medium embodiment.

FIG. 16 illustrates an example computer environment.

FIG. 17 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘extended reality’ (“XR”) services. XR services may refer to, or may be referred to as, anything reality services. XR services may comprise VR applications, which are widely adopted XR applications that provide an immersive environment that can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed Reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling a user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at an XR capable device is desirable. Accordingly, a user equipment device accessing XR services, or traffic flows of an XR session, may be associated with certain QoS parameter criterion/criteria to satisfy performance targets of the XR service. Measured traffic values, or metrics, may correspond to a QoS, or analyzed with respect to, parameter criterion/criteria, such as, for example, a data rate, an end-to-end latency, or a reliability.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

Multi-modal XR applications may integrate different technologies to offer a versatile and comprehensive user experience. For example, a multi-modal XR application might use VR to immerse users in a virtual training environment and then seamlessly switch to AR or MR to provide real-time feedback or overlay instructional information corresponding to physical objects that may appear in an environment viewed by an XR user. Such feedback or instructional information may relate to stationary objects or may be information that does not change frequently and may be referred to as stable information.

An advantage of multi-modal XR applications is the adaptability to facilitate different contexts and different user preferences. An XR application can provide varying levels of immersion and interaction, allowing users to choose the most suitable mode of engagement based on the user's needs or the specific task at hand. Additionally, multi-modal XR can enable collaborative experiences, allowing users in different physical locations to interact within the same virtual space.

Uses of multi-modal XR applications extend beyond entertainment and gaming, with widespread adoption in fields such as healthcare, education, engineering, and marketing. Medical practitioners can use multi-modal XR applications to simulate complex surgeries, educators can create interactive and immersive learning experiences, and architects can visualize and modify building designs in real-time.

To achieve goals of many XR use cases, it is desirable that low radio latency and high capacity be maintained during an XR session. Due to the nature of time-varying capacity congestion and conditions that affect time and frequency resource availability, downlink and uplink CODECs, which may be used for generating and rendering ultra-high-quality downlink and uplink traffic streams, may be adjusted, adapted, or otherwise changed to match real-time capacity and resource conditions (e.g., congestion conditions). For example, it may be preferable from a user experience perspective to slightly reduce a CODEC rate used to facilitate transmission of a stream of video traffic (e.g., reduce overall streaming quality), to match a degraded overall radio capacity condition, and experience little to no per-packet decoding errors and/or extended buffering delays, than to adopt an ultra-high quality CODEC that may not match real-time radio link congestion conditions and that may result in random per-packet delays and drops. In the downlink direction, CODEC adaptation is feasible according to conventional techniques because a RAN node/edge XR server is typically aware of a congestion state corresponding to one or more downlink radio link(s) being facilitated by the RAN node, and thus the RAN node can efficiently fine tune downlink XR streaming CODECS. However, in the uplink direction (e.g., from a XR WTRU device toward a RAN node), CODEC adaptation is not feasible according to conventional techniques and is therefore, according to conventional techniques, treated as a best effort and reactive optimization operation. The problem of a user equipment being unable to adapt an uplink CODEC to uplink link congestion according to conventional techniques is at least partially due to the fact that UE/WTRU devices, which generate the uplink traffic, are not aware of uplink congestion experienced by the RAN node, (e.g., a user equipment is not aware of whether fast uplink resources are available to be scheduled for facilitating transmission of uplink traffic). To solve problems existing with conventional techniques, embodiments disclosed herein may facilitate dynamic congestion reporting by a RAN node to a user equipment of actual uplink congestion and the user equipment adapting a quality processing level, or a CODEC, to apply to transmitting of buffered uplink traffic based on the reported congestion information received from the RAN node.

According to example some example embodiments, a RAN node may dynamically, in real-time, track, calculate, and report to a user equipment an overall set of uplink performance indicators, representing how much congestion is being experienced by an uplink interface. According to example embodiments disclosed herein, a RAN node may dynamically and temporarily switch an established bearer, and radio setting(s) associated therewith, being used to deliver uplink traffic from a user equipment to the RAN node and with respect to which radio performance/quality-of-service targets are expected to be violated due to the uplink congestion determined by the RAN node, from a current radio priority pipeline (e.g., a radio bearer) to a higher quality/priority radio pipeline/bearer. Accordingly, using embodiments disclosed herein a RAN node may compensate for degraded radio performance corresponding to uplink traffic streams, which performance is degraded due to the currently detected uplink congestion, by dynamically switching to a higher priority bearer.

According to conventional techniques, data radio bearer (“DRB”) assignment at the RAN node is solely based on a type of service a user equipment device has requested (e.g., a specific DRB may be selected by a RAN node to facilitate voice conversation traffic and a different specific DRB to facilitate delivery of video traffic). According to embodiments disclosed herein, congestion-driven dynamic DRB assignment may be made by a RAN node by dynamically and temporarily switching from one DRB to another, higher-priority, DRB solely based on detecting real time uplink congestion which may likely lead to violating uplink radio targets corresponding to user equipment devices. In an example embodiment, a user equipment may be eligible, or enabled, for such dynamic temporary bearer quality switching based on a subscription corresponding to the user equipment.

According to conventional techniques, modulation and coding schemes (“MCS”) for downlink and uplink directions are solely determined by the RAN node and solely based on coverage/quality conditions (e.g., solely based on signal strength measurement values reported to the RAN node by one or more user equipment devices). Instead, according to example embodiments disclosed herein, a user equipment may locally determine, and report back to a serving RAN node, an uplink MCS that is not only based on the device-determined radio coverage/quality but that may also be based on real-time uplink congestion conditions.

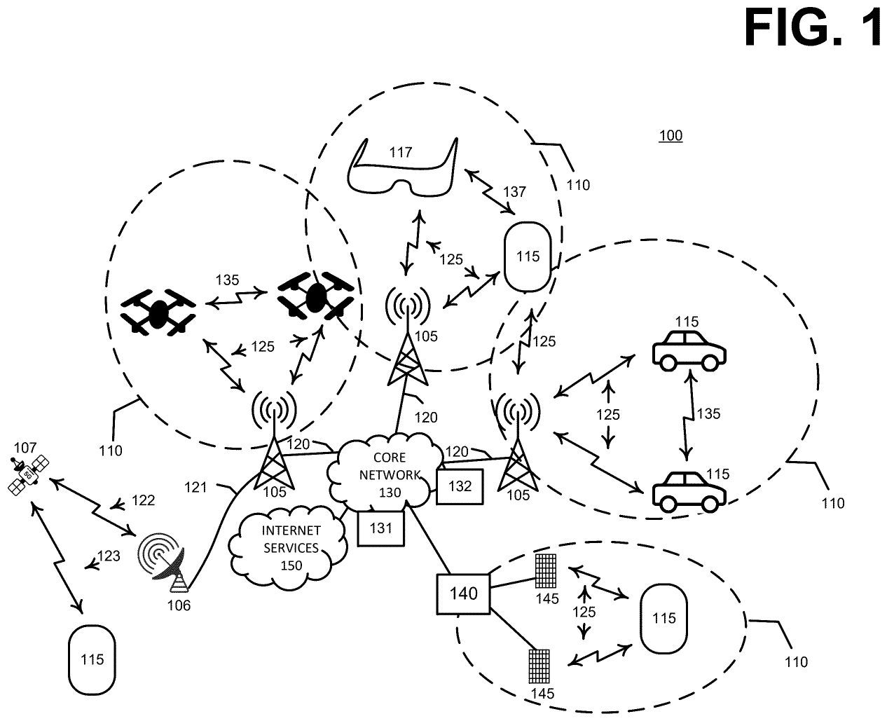

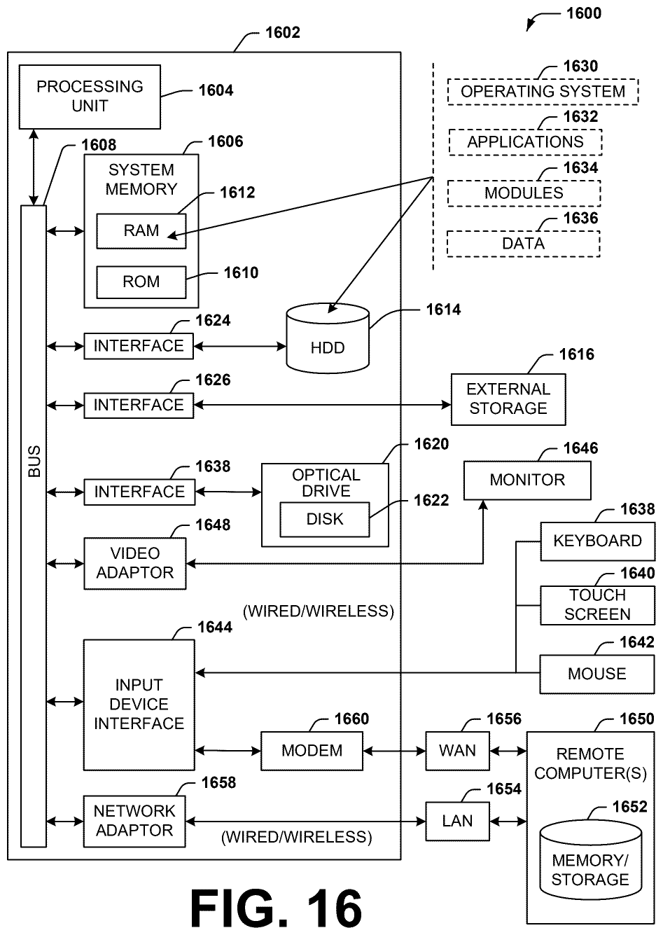

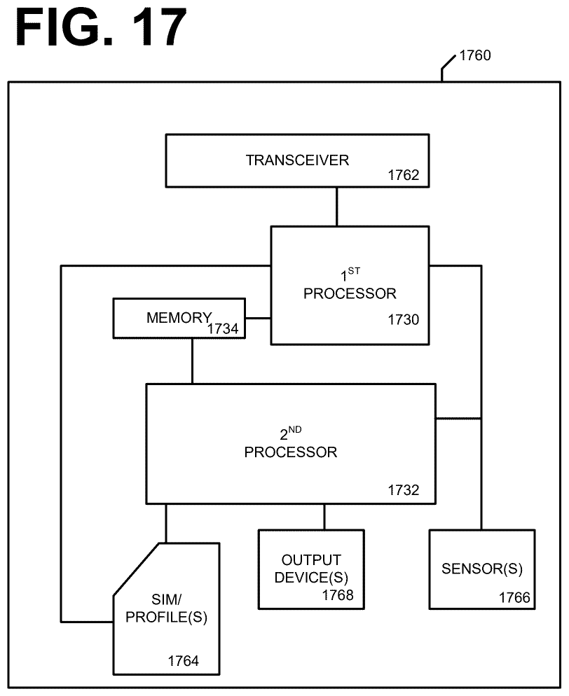

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, such as XR appliance 117, may transmit or receive wireless signals with a RAN base station 105 via a long-range wireless link 125, or the UE/XR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a RAN base station 105 and over a short-range wireless link. XR appliance 117 may also communicate with a wireless UE via a cable, or other wired connection. An XR appliance 117 may offload processing functionality or functionality related to communicating with a RAN, to a user equipment 115, which may be referred to as an intermediate user equipment or an XR processing unit. An XR processing unit or a RAN, or a component thereof, may be implemented by one or more computer components that may be described in reference to FIG. 16. An XR processing unit may also comprise components described in reference to FIG. 17.

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1: M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHZ), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

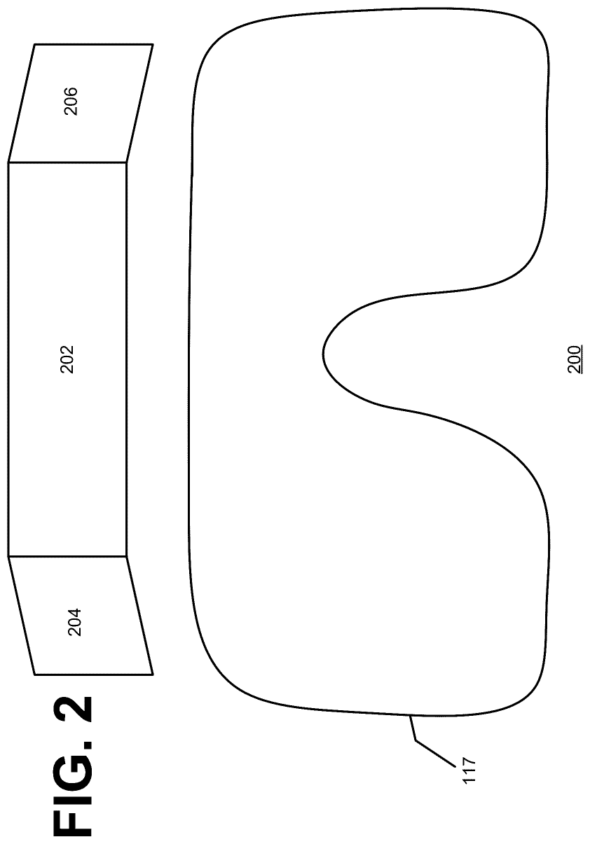

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in FIG. 2, portions 202, 204, and 206 are delineated by distinct lines, but it will be appreciated that hardware or software may facilitate gradual transition from main and peripheral information display. Appliance 117 may generate signals comprising information indicative of movement or manipulation of the appliance, which may be caused by a user of the appliance. Such movement or manipulation may be referred to as haptic movement or manipulation. A haptic movement or manipulation experienced by an appliance 117 may be referred to as a haptic experience.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g., latency) and reliability levels are required for a reasonable end user experience. For example, compared to a 5 Mbps URLLC link with a 1 ms radio latency budget, some XR applications require 100 Mbps links with about 2 mS allowed radio latency.

From research, several characteristics have been determined with respect to XR data traffic: (1) XR traffic characteristics are typically periodic with time-varying packet size and packet arrival rate; (2) XR capable devices (e.g., smart glasses, projection wearables, etc.) may be more power-limited than conventional mobile handsets, due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames requires broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR service may be at least partially determined according to satisfaction of a user of the XR services. Each XR-service-using user equipment device may be associated with certain QoS parameter criterion/criteria with respect to which measured values, or metrics, corresponding to traffic flows that facilitate XR service may be analyzed. Adjusting scheduling of traffic such that a measured traffic flow metric satisfies a QoS parameter, such as, for example, a data rate, an end-to-end latency, or a reliability may be beneficial to a user's XR experience.

A 5G NR radio system typically comprises a physical downlink control channel (“PDCCH”) and a physical uplink control channel (“PUCCH”), which may be used to deliver downlink and uplink control information, respectively, with respect to wireless user equipment devices. A 5G control channel may facilitate operation according to requirements of URLLC and eMBB use cases and may facilitate an efficient coexistence between such different QoS classes.

### Adaptive Bearer Congestion Signaling.

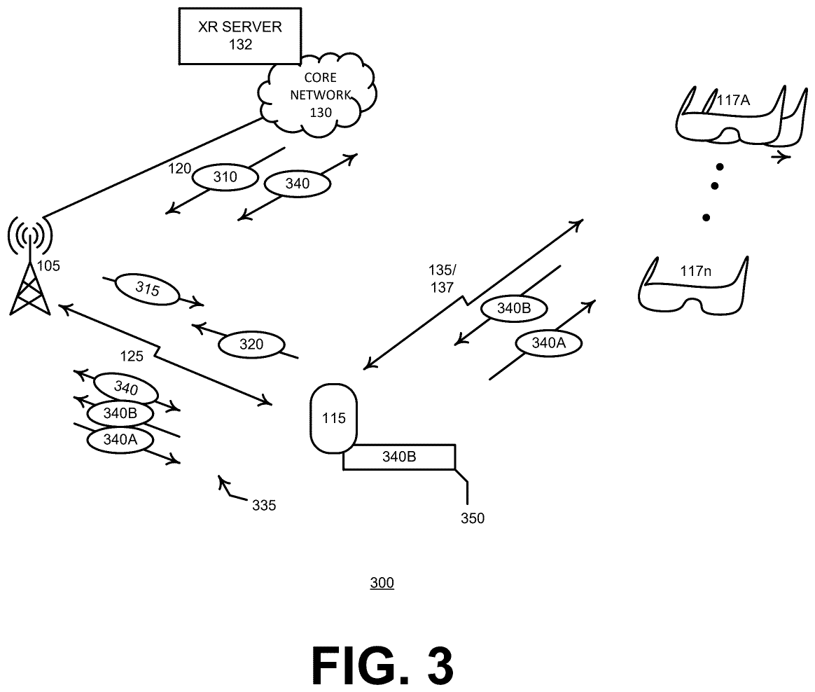

Turning now to FIG. 3, the figure illustrates an example environment 300. Environment 300 may comprise radio network node 105 in communication with user equipment 115. A communication session 335 may be established, or may have been established, between node 105 and user equipment 115 and may facilitate delivery of traffic 340. In an example embodiment, multiple extended reality appliances 117 may be tethered to user equipment 115, which may be an extended reality processing unit user equipment. In an example embodiment, multiple user devices, such as laptop computers or tablets may be tethered to user equipment 115 that may function as a hub that provides wireless connectivity with node 105 to the multiple user devices. User equipment 115 may be generically referred to as a wireless transmit receive unit (“WTRU”). ‘User equipment’, ‘wireless transmit receive unit’, ‘XR processing unit’, or ‘processing unit’ may be interchangeably used herein. An appliance 117 may be referred to as an end XR appliance in reference to the relationship of being at an end of a communication session, with respect to RAN node 105, with extended reality processing unit 115 being located intermediate to the RAN node and the appliance. It will be appreciated that a reference to an appliance 117 may be a reference to a user device such as a laptop computer or tablet and an appliance 117 may be capable of wireless radio communication with RAN node 105. In an example embodiment, RAN node 105 may comprise a terrestrial radio network node. In an example embodiment, RAN node 105 may comprise a non-terrestrial radio network node. XR processing unit 115 may be more capable with respect to battery capacity (or may be supplied power via a wired power supply receiving power from an electrical wall outlet), or with respect to processing capability, than XR appliance 117. In an embodiment, a downlink traffic flow providing traffic to a peripheral portion 204/206 (shown in FIG. 2) of VR/XR appliance 117 may be related to, or responsive to, a downlink traffic flow carrying traffic to be displayed by a pose portion 202 of the appliance. Downlink traffic that is responsive to uplink traffic, such as haptic information conveyed via uplink control traffic, may be referred to as reactive traffic. In an example, two different traffic flows may respectively carry traffic directed to right side 202R and left side 202L of pose portion 202 and thus may be related. In another example, an uplink traffic flow may carry traffic related to a downlink traffic flow.

Facilitating extended reality services via cellular wireless communications may negatively impact spectral efficiency or energy consumption at RAN nodes or user equipment due to stringent combined requirements regarding capacity, latency, and reliability, one or more of which may tend to impose contradictory requirements with respect to one or more of the other requirements. For example, to facilitate capacity and video rendering requirements corresponding to many XR applications, advanced multi-antenna system, sophisticated processing, and larger battery capacities may be used at end XR devices/appliance, which may cause an increase in weight and heat generated and may detract from appearance of an end XR device/appliance (e.g., XR glass, helmet, or bracelet, etc.).

Deployment of a high-capability (with respect to an XR appliance 117) intermediate XR processing unit 115 between RAN node 105 and an end XR appliance unit may facilitate relaying part of, or all of, XR radio traffic to or from the end XR device/appliance 117, thus reducing radio burden on the end XR appliance and facilitating the XR appliance being lower capability and lower weight than if the XR processing unit is not available to facilitate relaying of XR traffic between the appliance and RAN node. Burdens that may be offloaded from an end XR appliance 117 to intermediate XR processing unit 115 may comprise, for example, local traffic storage, processing of heavy control channel decoding, general processing, XR local video rendering, or advanced radio antenna manipulation. Thus, advanced receiver and processing capability may be facilitated for critical XR services as well as for general services with respect to an XR appliance 117, which may be lighter, more aesthetically pleasant, and more efficient than if the end XR appliance is not designed with capability to offload the burdens to intermediate XR processing unit 115.

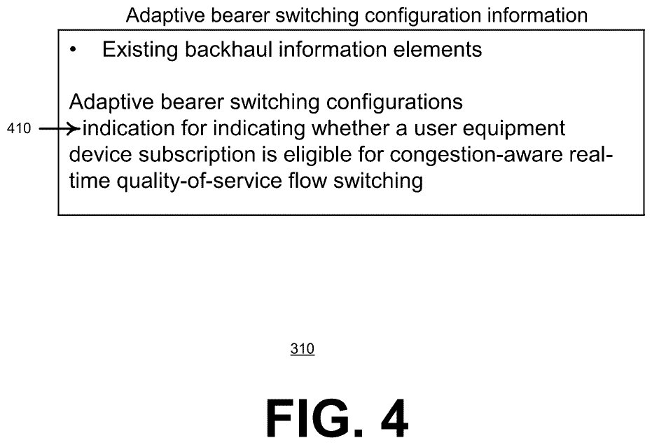

In an example embodiment, RAN node 105 may receive, from core network equipment 130, adaptive bearer switching configuration information 310. Information 310 may be indicative that delivery of the at least one uplink traffic flow 340B is to be accommodated, based on congestion determined by RAN node 105, according to a quality-of-service associated with traffic flow 340. Information 310 may be received before, during, or after establishment of connection/session 335. As show in FIG. 4, information 310 may comprise, in field 410, an indication, which may be a binary indication (e.g., true/false) indicative of whether a subscription associated with user equipment 115 is eligible for congestion-aware real-time quality-of-service (“QoS”) flow switching. Such a subscription may be referred to as a ‘VIP’ subscription and may be associated with a requirement that RAN node 105 attempt to increase radio bearer parameter quality/priority to facilitate traffic delivery according to the required quality-of-service if a bearer quality/priority corresponding to a bearer quality/priority being currently used for delivery of traffic cannot accommodate the required quality-of-service due to radio link congestion (e.g., congestion associated with link(s) 125) as determined by RAN node 105. The indication in field 410 may facilitate RAN node 105 reporting real time uplink congestion information (e.g., information regarding uplink congestion corresponding to link(s) 125) to active user equipment, (e.g., UE 115) wherein the uplink congestion information is to be usable to the user equipment to determine whether, or how to, adapt uplink processing or handling of uplink streams associated with session 335 according to the congestion information. If a device subscription associated with user equipment 115 is determined to be eligible for congestion-aware real-time QoS flow switching (e.g., the subscription is a ‘VIP’ subscription), RAN node 105 may attempt to compensate radio performance corresponding to session 335 based on uplink congestion determined by the RAN node.

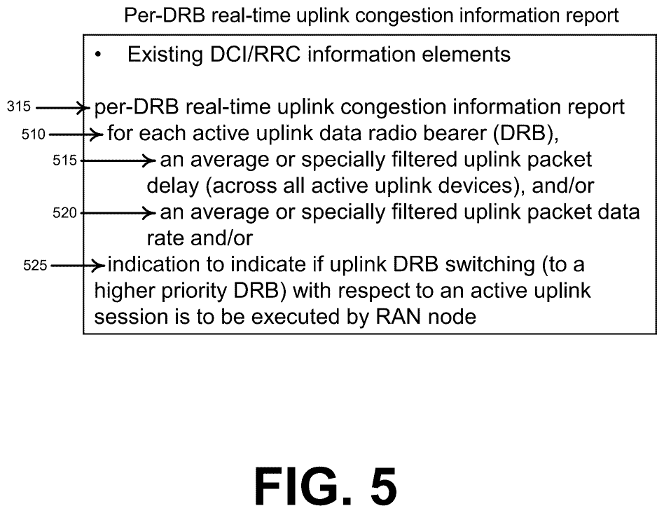

RAN node 105 may track, filter, calculate, buffer, or otherwise process and/or determine real-time uplink congestion information. The uplink congestion information may be determined for each of multiple uplink data radio bearers (“DRB”) being facilitated by RAN node 105, even for DRBs not being used to facilitate traffic delivery with respect to UE 115. In an example embodiment, information corresponding to congestion that RAN node 105 may determine may comprise an average, or specially filtered, uplink packet delay for all active uplink devices that are connected with the RAN node. In an example embodiment, information corresponding to congestion that RAN node 105 may determine may comprise an average, or specially filtered, uplink packet data rate. RAN node 105 may attempt to calculate an overall uplink radio interface health and congestion status with respect to all active QoS pipelines, (e.g., with respect to all DRBs being facilitated by the RAN node). For example, RAN node 105 may determine an overall uplink congestion with respect to one or more uplink radio link(s) 125 over a configured period, for example the previous 30 minutes. The RAN node may determine that a per-DRB uplink latency is monotonically increasing and is currently above a maximum link latency criterion/threshold, which may be a configured criterion. Based on determining a negative change of uplink real time performance indicators (e.g., a reduction of a DRB data rate corresponding to a particular DRB or an increase delay corresponding to a particular DRB) that equals or exceeds a configured change criterion/threshold, RAN node 105 may compile and transmit at least one per-DRB real-time uplink congestion information report 315, toward devices having active uplink sessions with the RAN node (e.g., toward UE 115), via device-specific or device-common downlink control channels. A report 315 may be referred to as a bearer congestion report and may be indicative of at least one congestion management indication corresponding to the at least one determined congestion. As shown in FIG. 5, report 315 may be indicative of at least one congestion management indication, corresponding to a particular DRB indicated in field 510. For example, for a DRB indicated in field 510, report 315 may indicate in field 515 a packet delay parameter value or in field 520 an average packet data rate. RAN node 105 may detect, or predict (e.g., using an artificial intelligence learning model), a substantial uplink congestion with respect to a particular DRB and based thereon may trigger reporting, via at least one report 315, uplink congestion information to active user devices having interactive uplink sessions, for example UE 115 having active session 335.

In an example embodiment, based on determining, or being configured with, performance targets, or QoS targets, corresponding to one or more active uplink traffic flows (e.g., traffic flow 340B) associated with an active device 115 that are not being satisfied (e.g., due to current, real-time congestion with respect to a DRB facilitating the session 335), and based on a VIP subscription associated with device 115 being determined to be eligible for congestion-aware real-time QoS flow switching, RAN node 105 may temporarily switch a quality/priority corresponding to an uplink DRB currently facilitating the one or more uplink traffic flow(s) to a higher quality/priority uplink DRB that can satisfy the determined, or configured, performance targets associated with the uplink traffic flows. Thus, RAN node 105, due to the detected uplink congestion, may facilitate, and indicate via field 525, congestion-driven switching of device 115 to a higher priority treatment (e.g., a higher quality/priority DRB) to compensate for radio performance loss due to the predicted, or currently predicted, congestion. For example, if RAN node 105 determines that an additional five milliseconds is needed for scheduling traffic packets corresponding to uplink traffic flow 340 that may be buffered in buffer 350 corresponding to UE 115 due to delay determined with respect to a DRB that is facilitating delivery of uplink traffic 340B, RAN node 105 may prioritize uplink traffic 340B to a higher priority DRB corresponding to at least five milliseconds faster scheduling to facilitate UE device 115 experiencing consistent radio uplink performance with respect to traffic flow 340B that satisfies a QoS associated with the traffic flow. Accordingly, RAN node 105 may schedule packets, corresponding to flow 340B buffered in buffer 350, and receive the packets according to the updated uplink DRB. If DRB switching is indicated in field 525, UE 115 may disregard, or use for statistical purposes, for example training an artificial intelligence learning model, information indicated in fields 515 or 520.

In an example embodiment, if DRB quality switching is not indicated in field 525, UE may, based on information indicated in field 515 or field 520, determine a processing quality to apply to transmission of packets 340B buffered in buffer 350. A processing quality may correspond to an encoding decoding protocol (e.g., a CODEC). RAN node 105 may receive, from UE 115, a modulation and coding scheme report 320 indicative of at least one modulation scheme or at least one coding scheme determined by the UE, wherein the at least one modulation scheme or the at least one coding scheme is to be usable by the radio network node to decode the traffic 340B that may be processed according to a CODEC determined by UE 115 based on congestion management indication information indicated by fields 515 or 520.

### Congestion-Aware Device Uplink Rate Adaptation.

Continuing with reference to FIG. 3, in an example embodiment, UE 115, which may be, or which may function as, an XR WTRU with respect to active uplink session 335, may receive, in the downlink direction from the serving RAN node, a per-DRB real-time uplink congestion information report 315, which may be referred to as a bearer congestion report, via device-specific or device-common downlink control channel(s). As described above, report 315 may comprise in field 515 an average, or specially filtered, uplink packet delay corresponding to one or more user equipment devices that may include UE 115, and in field 520 an average or specially filtered uplink packet data rate. In field 525, report 315 may comprise at least one congestion management indication indicative of whether RAN 105 has switched, or will likely switch, a quality/priority corresponding to a DRB, indicated in field 510, corresponding to traffic flow 340B to a higher quality/priority. An indication in field 525 may be usable by UE 115 to determine that RAN node 105 has acted, or will likely soon act, to adjust a quality or priority associated with delivery of uplink traffic 340B to compensate for an expected performance degradation corresponding to latency or data rate parameter values indicated in field(s) 515 or 520. Accordingly, if field 525 is indicative that RAN node 105 has adjusted/switched a DRB quality/priority associated with scheduling or delivery of traffic 340B, UE device 115 may only retain/process congestion information received in fields 515 or 520 for statistical processing (e.g., AI learning model training) and may avoid acting to adjust a CODEC or modulation or coding scheme change with respect to transmitting traffic 340B that may be buffered in buffer 350.

Based on receiving a report 315 that is indicative of uplink performance metrics that violate performance targets/criteria (e.g., report 315 indicates a per-DRB delay exceeding a maximum allowable delay corresponding to uplink session 335 or traffic flow 340 associated therewith) and based on a lack of indication in field 525 of an indication indicative that RAN node 105 has, or likely will, adjust a quality/priority associated uplink scheduling/delivery of traffic 340B buffered in buffer 350 to a higher priority DRB switching (even though an actual higher quality/priority determined by the RAN node may not be indicated in field 525), XR WTRU 115 may determine a streaming CODEC and application data rate that can likely be facilitated by radio link(s) 125 that may be experiencing congestion corresponding to information indicated in field 515 or field 520 (e.g., er-DRB real-time performance metrics. The determined CODEC may be a second CODEC determined with respect to a first CODEC that may be used, or may have been used, before UE 115 receives report 315. Thus, based on information indicated in report 315, UE 115 may determine that real-time uplink congestion may result in violation of radio targets/criteria associated with pending uplink traffic 340B buffered in buffer 350 and the UE may determine that serving RAN node 105 has not indicated DRB quality-priority switching in field 525, and the UE may trigger local adaptation of an updated processing quality to be applied to uplink session 335 such that traffic 340B may be scheduled or transmitted based on real time congestion corresponding to at least one uplink radio link(s) 125 and such that a QoS associated with the second CODEC is satisfied, even if the second CODEC corresponds to a lower streaming quality than the first CODEC. For example, UE 115 may determine a new/updated target data rate (or spectral efficiency) that can be satisfied during current congestion conditions indicated by field 515 and 520, and accordingly, UE 115 may determine at least one updated, or second CODEC, that matches the updated determined spectral efficiency.

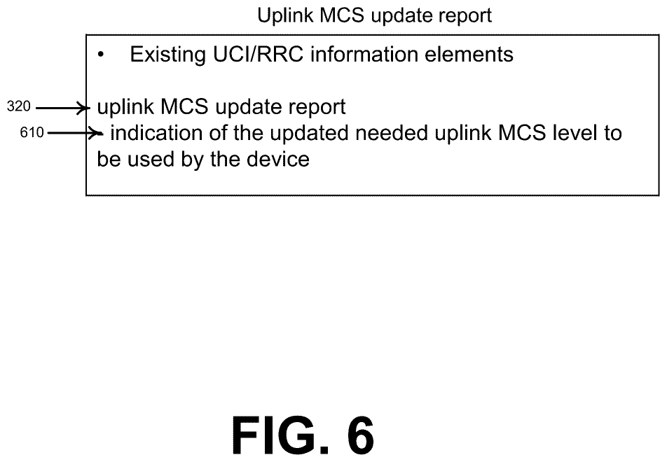

WTRU 115 may determine and adopt an updated uplink modulation and coding scheme (“MCS”) level that delivers a spectral efficiency matching the determined second CODEC and application data rate. UE device 115 may locally determine a corresponding MCS level that is sufficient enough to facilitate the determined second/updated CODEC. As shown in FIG. 6, WTRU 115 may transmit, in the uplink direction toward serving RAN node 105, an uplink MCS update report 320 that may comprise an indication in field 610 of the updated uplink MCS level to be used by UE device 115. Information conveyed via field 610 may facilitate RAN node 105 decoding received uplink traffic 340B that may be transmitted by UE 115 according to the updated MCS indicated in field 610. Unlike with conventional techniques, wherein a RAN node determines an uplink MCS and indicates to a user equipment the determined uplink MCS, because, according to example embodiments disclosed herein, an uplink MCS determination may occur locally at a user equipment, an MCS level indicated in field 610 helps RAN node 105 decode uplink traffic encoded or modulated according to an MSC scheme indicated in field 610.

In an example embodiment, based on an indication in field 525 that RAN node 105 has, or may, switch a DRB quality/priority to a higher quality/priority, WTRU 115 may continue operation according a current/first CODEC and application data rate regardless of per-DRB congestion information indicated via fields 510 or 515. Thus, in an example embodiment, if a subscription corresponding to UE 115 corresponds to DRB quality/priority switching by RAN node 105 (e.g., a VIP subscription is associated with a guarantee that RAN node 105 is to attempt to accommodate a subscribed-to QoS), the RAN node may schedule transmission of uplink packets 340B according to a higher quality/priority DRB such that, even though congestion corresponding to an uplink link 125 may preclude transmission of traffic 340B according to a currently established DRB such that a QoS associated with traffic 340B is satisfied, RAN node 105B may upgrade, or increase, a quality of a DRB used to schedule and deliver traffic 340B such that UE 115 does not need to make an operational change to continue transmitting uplink traffic 340B in satisfaction of at least one QoS criterion associated with traffic 340B or a subscription associated therewith.

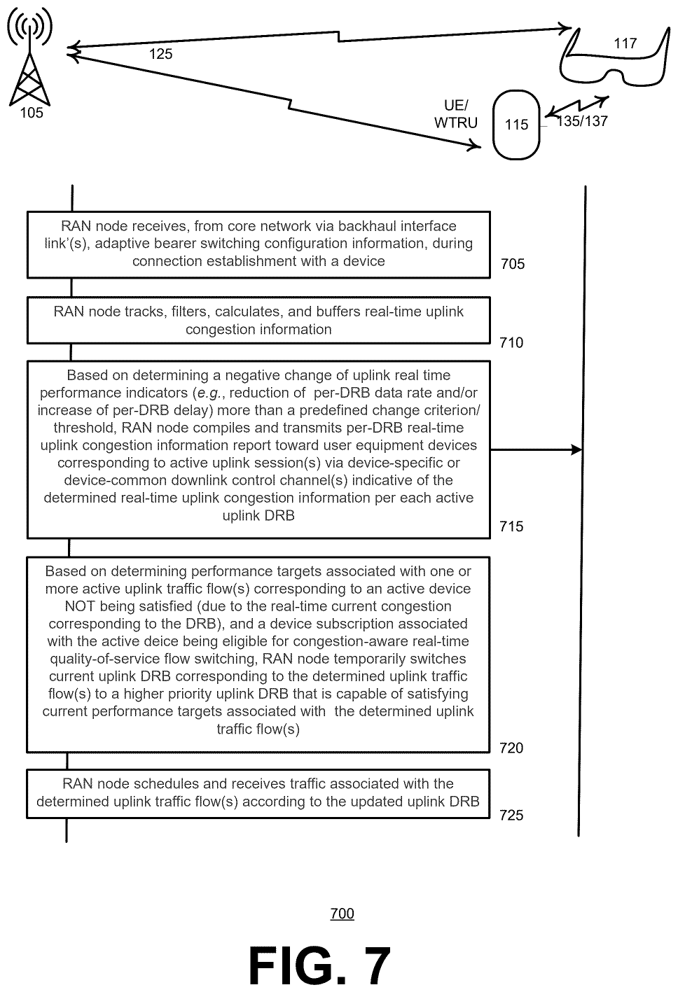

Turning now to FIG. 7, the figure illustrates a timing diagram of an example embodiment method 700 of radio network node 105 facilitating determining a congestion corresponding to a communication session, for example session 335 described in reference to FIG. 3, to which, or via which, WTRU user equipment/processing unit 115, may in turn be facilitating communication session 335 with respect to at least one extended reality appliance 117. At act 705, RAN node 105 may receive, from core network equipment 130 via backhaul interface link(s) 120 shown in FIGS. 1 and 3, adaptive bearer switching configuration information during connection establishment with UE/WTRU 115. The configuration information received at act 705 may be adaptive bearer switching configuration information 310 described in reference to FIGS. 3 and 4 and may comprise a binary indication of whether a subscription corresponding to UE 115 is eligible for, or has been configured for (e.g., according to a subscription), congestion-aware real-time QoS flow switching. At act 710, RAN node 105 may track, filter, calculate, buffer, or otherwise process real-time uplink congestion information. Uplink congestion information processed by RAN node 105 at act 710 may comprise, for each of at least one uplink DRB being facilitated by RAN node 105 with respect to one or more user equipment device(s)/WTRU device(s), an average, or specially filtered, uplink packet delay, and/or an average or specially filtered uplink packet data rate, which may be determined based on traffic being facilitated by RAN node 105 with respect to all devices actively transmitting uplink traffic to the RAN node. At act 715, based on determining a negative change of uplink real time performance indicators (e.g., a reduction of a DRB data rate and/or an increase of DRB delay corresponding to a DRB being used to facilitate uplink transmission of traffic from UE 115 to RAN node 105) equal to or greater than predefined, determined, or configured, change criterion/threshold, RAN node 105 may compile and transmit a per-DRB real-time uplink congestion information report (e.g., report 315), toward user equipment devices having active uplink communication sessions with RAN node 105, via device-specific or device-common downlink control channel(s). A report transmitted at act 715 may comprise determined real-time uplink congestion information corresponding to each of at least one active uplink DRB. At act 720, based on determining that performance/QoS target(s)/criteria corresponding to one or more active uplink traffic flows corresponding to WTRU 115 are not being satisfied due to the real-time current congestion on a DRB being used to facilitate transmission of uplink traffic from WTRU 115 to RAN node 105, and based on a determination that a device subscription corresponding to UE 115 is indicative that the UE is eligible for congestion-aware real-time QoS flow switching, at least for traffic being facilitated by session 335, RAN 105 node may temporarily switch a current uplink DRB corresponding to an uplink traffic flow corresponding to session 335 to a higher priority uplink DRB that can accommodate the QoS associated with the traffic flow (e.g., based on a subscription), despite existence of congestion corresponding to radio link(s) 125 that may preclude a current DRB being used to transmit uplink traffic from WTRU 115 to RAN node 105 from satisfying the QoS. At act 725, RAN node 105 may schedule and receive uplink traffic from UE 115 according to the updated uplink DRB determined at act 720.

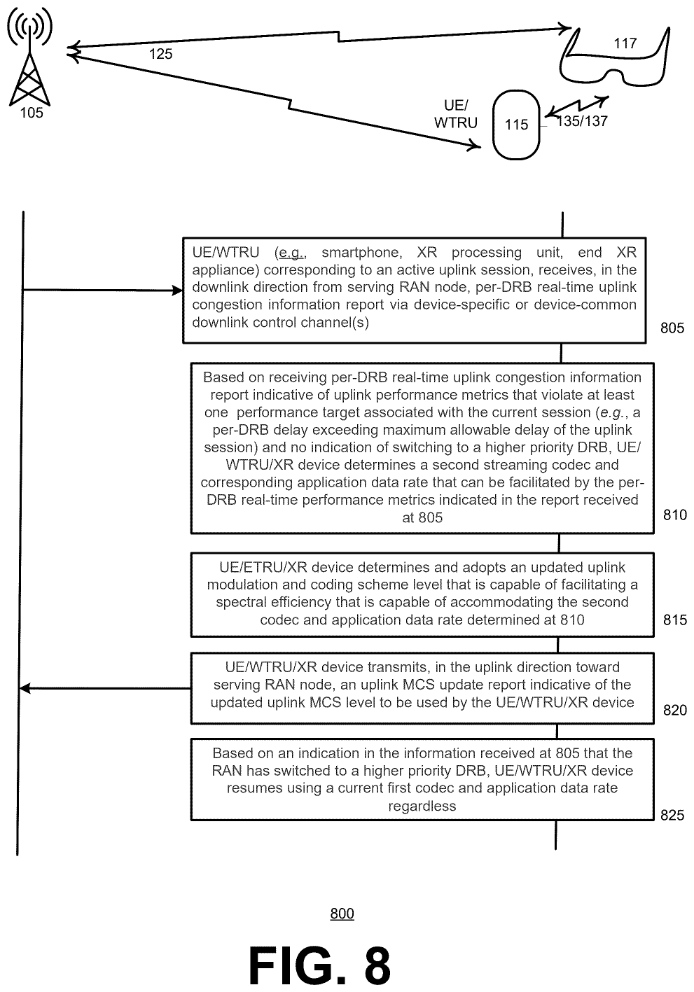

Turning now to FIG. 8, the figure illustrates a timing diagram of an example embodiment method 800 of WTRU 115 facilitating a communication session, (e.g., communication session 335 described in reference to FIG. 3), which may be an extended reality session between RAN node 105 and WTRU 115 or which may be a session between the RAN node and at least one extended reality appliance 117. At act 805, WTRU 115, having established a communication session, for example session 335, with RAN node 105, may receive, in the downlink direction from serving RAN node 105, a per-DRB real-time uplink congestion information report (e.g., report 315 described in reference to FIGS. 3 and 5), via device-specific or device-common downlink control channel(s). At act 810, based on receiving report 315 that may be indicative of uplink congestion/performance metrics that may indicate violation of, or failure to satisfy, at least one QoS target/criterion associated with session 335 (e.g., a per-DRB uplink delay exceeding a maximum allowable delay corresponding to the session) and non-presence of an indication in field 525 of report 315 that RAN 105 has switched, or may switch, a bearer facilitating uplink traffic of session 335 to a higher quality-higher priority DRB, WTRU 115 may determine a second, or updated, streaming CODEC and an updated/second application data rate that can be achieved during congestion indicated by the report received at act 805. At act 815, WTRU 115 may determine and adopt an updated uplink modulation and coding scheme level corresponding to a spectral efficiency that can accommodate the determined second CODEC or determined second application data rate. At act 820, WTRU 115 nay transmit, in the uplink direction toward serving RAN node 105, an uplink MCS update report (e.g., report 320 described in reference to FIGS. 3 and 6), that may comprise an indication of the updated MSC scheme to be used by WTRU 115. Based on presence of an indication of a higher priority DRB switching in the received per-DRB real-time uplink congestion information report (e.g., based on an indication in field 525 of report 315 that RAN node 105 has switched, or likely will switch, to a higher quality DRB to accommodate transmission of uplink traffic buffered by WTRU 115) WTRU 115 may resume/continue operations according to a current (e.g., first) CODEC and application data rate regardless of per-DRB congestion information that may be indicated in fields 515 or 520 of report 315.

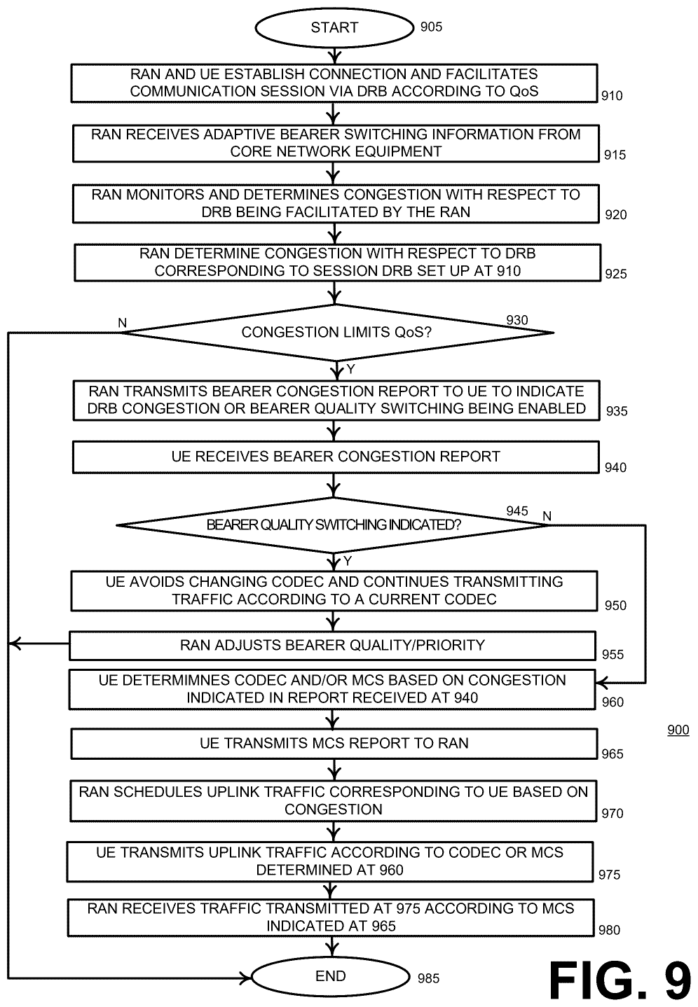

Turning now to FIG. 9, the figure illustrates a flow diagram of an example embodiment 900. Method 900 begins at act 905. At act 910, a radio network node, for example node 105 shown in FIG. 3, and a user equipment, for example WTRU 115 shown in FIG. 3, may establish a connection and the radio network node may facilitate a communication session with the WTRU via at least one data radio bearer. A specified quality-of-service may be applicable to the communication session and traffic associated therewith delivered via the at least one data radio bearer. At act 915, the radio network node may receive, from core network equipment, adaptive bearer switching information, for example information 310 described in reference to FIGS. 3 and 4. At act 920, the radio network node may monitor and determine radio link congestion with respect to data radio bearers being used to facilitate communication between the radio network node and at least one user equipment that may comprise WTRU 115. The radio network node may determine a total congestion, for example a total uplink congestion, associated with all data radio bearers being facilitated by the radio network node and may determine a per-DRB congestion, or effects (e.g., delay or data rate) of congestion per DRB being used to facilitate traffic delivery with respect to the user equipment. At act 925, the radio network node may determine a congestion, or a congestion effect, with respect to at least one data radio bearer corresponding to the communication session set up with the WTRU at act 910. At act 930, the radio network node may determine whether a congestion determined at act 925 may limit facilitating a traffic flow corresponding to the communication session set up at act 910 according to a quality-of-service associated with the traffic flow. For example, if an uplink congestion corresponding to a radio link between the user equipment and the radio network node being used to facilitate delivery of uplink traffic from the user equipment to the radio network node would reduce, or eviscerate, a capability of the radio network node to schedule uplink resources corresponding to a current data radio bearer being used to facilitate delivery of uplink traffic associated with the session established at act 910 according to a quality-of-service associated with, or required by, the traffic flow, the radio network node may determine that the congestion corresponding to the radio link in the uplink direction would limit delivery of uplink traffic from the user equipment to the radio network node according to the required quality-of-service. If a determination is made at act 930 that congestion in the uplink direction between the user equipment and the radio network node would not impair delivery of uplink traffic from the user equipment to the radio network node according to a quality-of-service associated with the uplink traffic, method 900 may advance to act 985 and end.

Returning to description of act 930, if the radio network node determines that congestion in the uplink direction would likely impair delivery of uplink traffic from the user equipment to the radio network node according to a quality-of-service required by the traffic flow, or a subscription corresponding thereto, method 900 may advance to act 935. A determination made at act 930 may be based on analysis by the radio network node of the congestion determined at act 925 with respect to a quality-of-service criterion associated with the traffic (e.g., a latency criterion or a data rate criterion corresponding to the traffic). For example, if a latency determined at act 925 equals or exceeds a latency criterion associated with the traffic, or if a data rate that can be facilitated by a current DRB, based on the congestion determined at act 925, is equal to or lower than a data rate criterion associated with the traffic, the radio network node may determine at act 930 that congestion determined at act 925 would limit facilitation of delivery of uplink traffic from the user equipment to the radio network node according to a quality-of-service associated with the traffic.

At act 935, the radio network node may transmit, to the user equipment, a bearer congestion report (e.g., report 315) that may be indicative (e.g., in fields 515 and/or 520) of a congestion, or effect(s) thereof, determined at act 925 and/or indicative that data radio bearer switching is enabled with respect to the user equipment (e.g., via an indication in field 525 of report 315). The radio network node may determine that data radio bearer switching is enabled based on evaluation of configuration settings corresponding to a subscription for services that include delivery of traffic associated with the session established at act 910. For example, a subscription, associated with the user equipment, that is facilitating the session establish at act 910, may specify, or be indicative to the radio network node, that, if physically possible via radio link(s) between the user equipment and radio network node, (e.g., link(s) 125), traffic associated with the session established at act 910 is to be delivered according to a specified quality-of-service even if link congestion increases such that continuing to deliver the traffic via currently-used radio data bearer radio settings would result in a quality-of-service corresponding to the traffic being less than the specified quality of service.

At act 940, the user equipment may receive the bearer congestion report transmitted at act 935. At act 945, the user equipment may determine whether the report received at act 940 comprises a bearer quality switching indication indicative that the radio network node may adjust, change, upgrade, or otherwise improve data radio bearer parameter settings to facilitate delivery of the traffic from the user equipment to the radio network node according to a specified quality-of-service that may be required by, or guaranteed by, a subscription associated with the user equipment. If the user equipment determines at act 945 that a bearer congestion report received at act 940 comprises an indication that the radio network node has enabled bearer quality switching, method 900 may advance to act 950. At act 950, the user equipment may avoid changing a CODEC from a CODEC currently being used to facilitate uplink delivery of traffic corresponding to the session established at act 910 (e.g., the user equipment may continue to use a high-quality CODEC instead of selecting a lower-quality CODEC because congestion effects indicated by report 315). At act 955, the radio network node may adjust bearer settings to facilitate a bearer having a higher quality or priority than a bearer quality that was previously being used to facilitate uplink delivery of traffic from the user equipment to the radio network node associated with the session established at act 910. Thus, if a subscription associated with the session established at act 910 requires that the radio network node facilitate a specified quality-of-service associated with the session, and if physical radio link congestion can physically facilitate the specified quality-of-service, the radio network node may change data radio bearer settings such that a data radio bearer being used to facilitate uplink transmission of traffic from the user equipment to the radio network node is capable of facilitating the specified quality-of-service without the user equipment altering operation or settings associated with uplink delivery of traffic corresponding to the session established at act 910 (e.g., without the user equipment reducing CODEC quality to facilitate uplink transmission of buffered uplink traffic). Method 900 advances from act 955 to act 985 and ends.

Returning to description of act 945, if the user equipment determines that a bearer congestion report received at 940 does not indicate that bearer quality switching has been enabled by the radio network node, method 900 advances to act 960. At act 960, the user equipment may determine a different CODEC than the user equipment has been using to facilitate uplink delivery of traffic to the radio network node before the user equipment received the bearer congestion reported act 940. The user equipment may determine a new CODEC based on congestion indicated in the report received at act 940 based on a delay value indicated in field 515 or data rate value indicated in field 520. The user equipment may also determine an updated modulation scheme or coding scheme, or modulation and coding scheme, based on the new/updated CODEC. At act 965, the user equipment may transmit to the radio network node a modulation and coding scheme report, for example report 320 described in reference to FIG. 3 and shown in FIG. 6, indicative of a modulation and/or coding scheme determined at act 960. At act 970, the radio network node may schedule uplink traffic that may be buffered at the user equipment based on the modulation and coding scheme indicated in a modulation and coding scheme report transmitted by the user equipment to the radio network node at act 965. At act 975, the user equipment may transmit uplink traffic that may be buffered at the user equipment to the radio network node according to a CODEC or according to a modulation scheme or coding scheme determined at act 960. At 980, the radio network node receives traffic transmitted by the user equipment at act 975 according to in modulation or coding scheme indicated in the report transmitted by the user equipment at act 965. Method 900 advances to act 985 and ends.

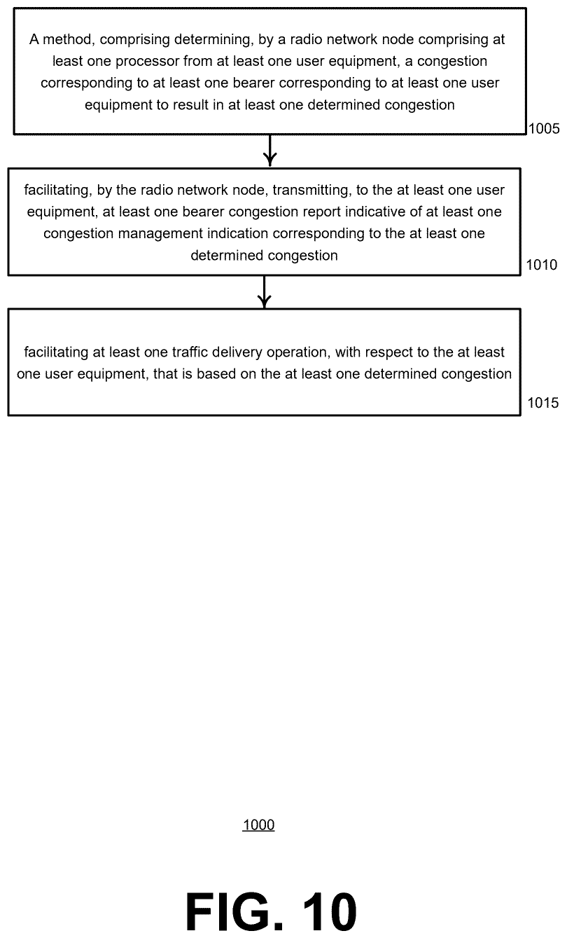

Turning now to FIG. 10, the figure illustrates an example embodiment method 1000 comprising at block 1005 determining, by a radio network node comprising at least one processor from at least one user equipment, a congestion corresponding to at least one bearer corresponding to at least one user equipment to result in at least one determined congestion; at block 1010 facilitating, by the radio network node, transmitting, to the at least one user equipment, at least one bearer congestion report indicative of at least one congestion management indication corresponding to the at least one determined congestion, and at block 1015 facilitating at least one traffic delivery operation, with respect to the at least one user equipment, that is based on the at least one determined congestion.

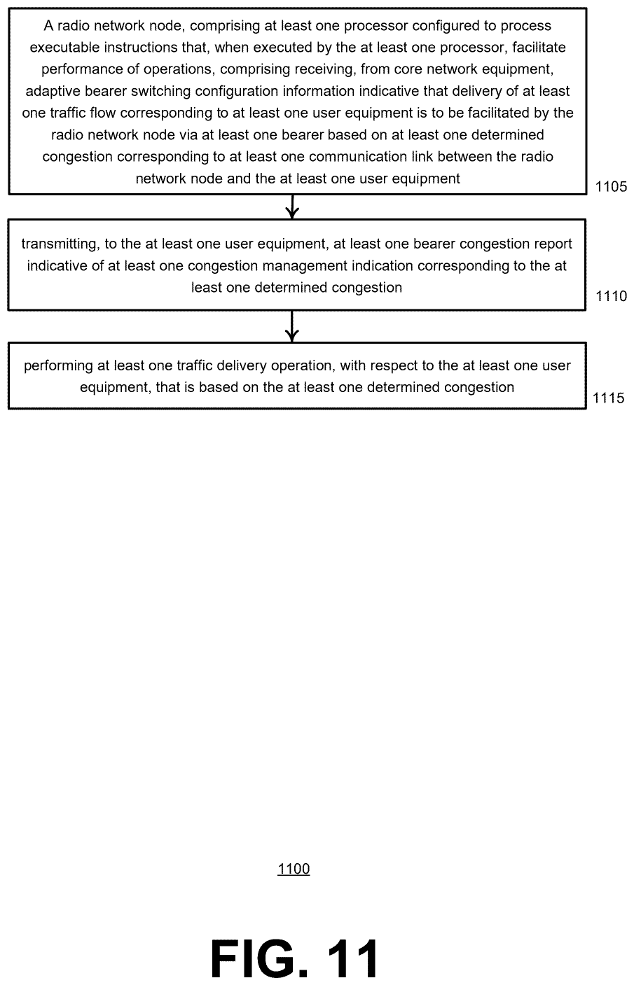

Turning now to FIG. 11, the figure illustrates a radio network node, comprising at block 1105 at least one processor configured to process executable instructions that, when executed by the at least one processor, facilitate performance of operations, comprising receiving, from core network equipment, adaptive bearer switching configuration information indicative that delivery of at least one traffic flow corresponding to at least one user equipment is to be facilitated by the radio network node via at least one bearer based on at least one determined congestion corresponding to at least one communication link between the radio network node and the at least one user equipment; at block 1110 transmitting, to the at least one user equipment, at least one bearer congestion report indicative of at least one congestion management indication corresponding to the at least one determined congestion; and at block 1115 performing at least one traffic delivery operation, with respect to the at least one user equipment, that is based on the at least one determined congestion.

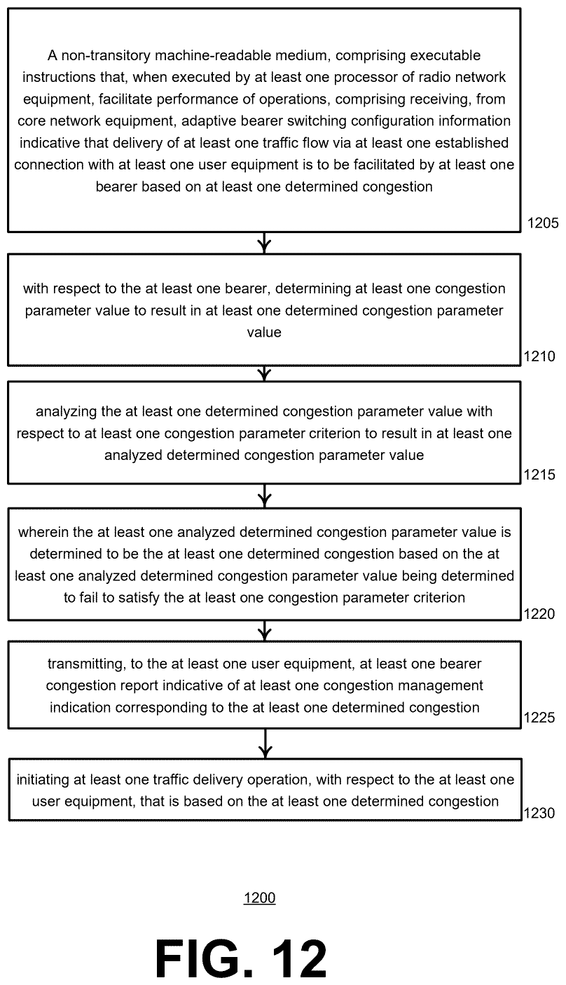

Turning now to FIG. 12, the figure illustrates a non-transitory machine-readable medium 1200 comprising at block 1205 executable instructions that, when executed by at least one processor of radio network equipment, facilitate performance of operations, comprising receiving, from core network equipment, adaptive bearer switching configuration information indicative that delivery of at least one traffic flow via at least one established connection with at least one user equipment is to be facilitated by at least one bearer based on at least one determined congestion; at block 1210 with respect to the at least one bearer, determining at least one congestion parameter value to result in at least one determined congestion parameter value; at block 1215 analyzing the at least one determined congestion parameter value with respect to at least one congestion parameter criterion to result in at least one analyzed determined congestion parameter value; at block 1220 wherein the at least one analyzed determined congestion parameter value is determined to be the at least one determined congestion based on the at least one analyzed determined congestion parameter value being determined to fail to satisfy the at least one congestion parameter criterion; at block 1225 transmitting, to the at least one user equipment, at least one bearer congestion report indicative of at least one congestion management indication corresponding to the at least one determined congestion; and at block 1230 initiating at least one traffic delivery operation, with respect to the at least one user equipment, that is based on the at least one determined congestion.

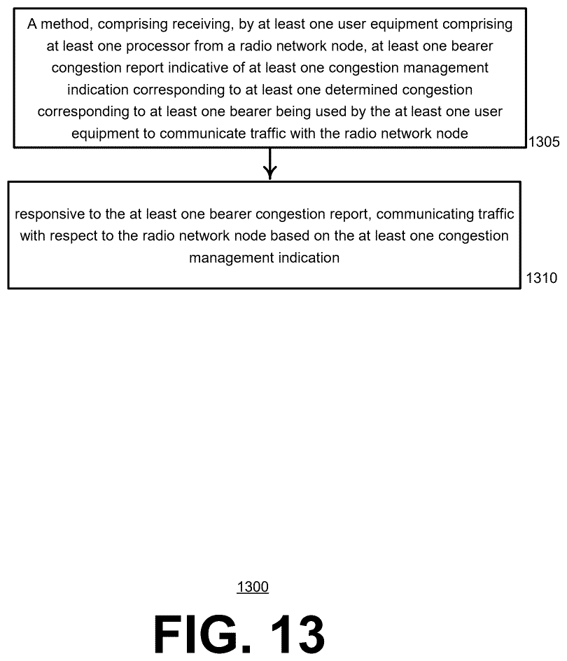

Turning now to FIG. 13, the figure illustrates an example embodiment method 1300 comprising at block 1305 receiving, by at least one user equipment comprising at least one processor from a radio network node, at least one bearer congestion report indicative of at least one congestion management indication corresponding to at least one determined congestion corresponding to at least one bearer being used by the at least one user equipment to communicate traffic with the radio network node; and at block 1310 responsive to the at least one bearer congestion report, communicating traffic with respect to the radio network node based on the at least one congestion management indication.

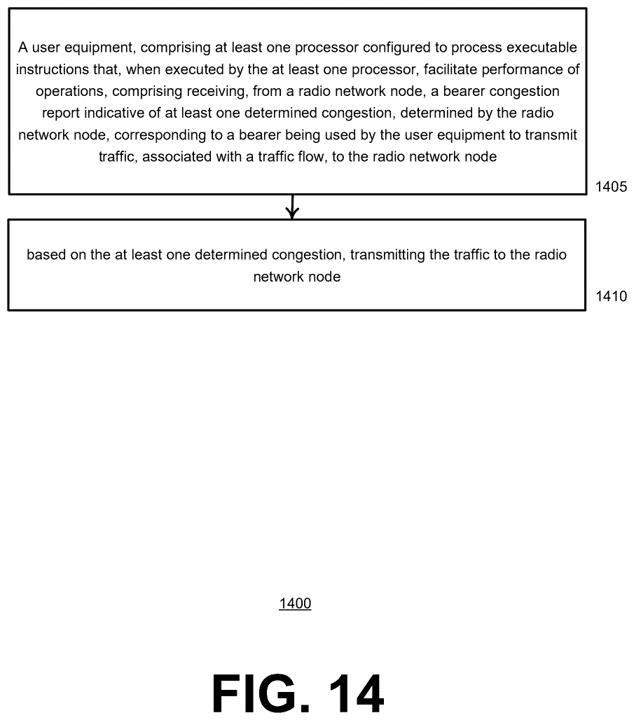

Turning now to FIG. 14, the figure illustrates a user equipment, comprising at block 1405 at least one processor configured to process executable instructions that, when executed by the at least one processor, facilitate performance of operations, receiving, from a radio network node, a bearer congestion report indicative of at least one determined congestion, determined by the radio network node, corresponding to a bearer being used by the user equipment to transmit traffic, associated with a traffic flow, to the radio network node; and at block 1410 based on the at least one determined congestion, transmitting the traffic to the radio network node.

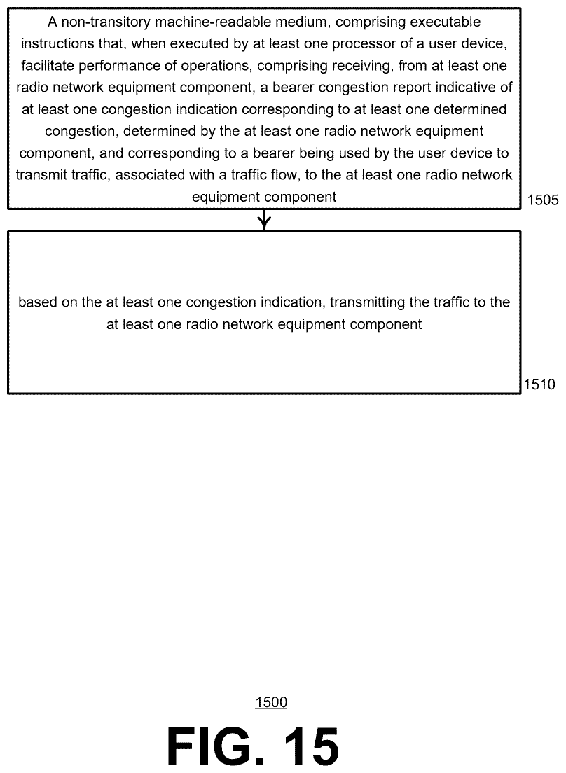

Turning now to FIG. 15, the figure illustrates a non-transitory machine-readable medium 1500 comprising at block 1505 executable instructions that, when executed by at least one processor of user device, facilitate performance of operations, comprising, receiving, from at least one radio network equipment component, a bearer congestion report indicative of at least one congestion indication corresponding to at least one determined congestion, determined by the at least one radio network equipment component, and corresponding to a bearer being used by the user device to transmit traffic, associated with a traffic flow, to the at least one radio network equipment component; and at block 1510 based on the at least one congestion indication, transmitting the traffic to the at least one radio network equipment component.

In order to provide additional context for various embodiments described herein, FIG. 16 and the following discussion are intended to provide a brief, general description of a suitable computing environment 1600 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors and may include a cache memory. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

Computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can comprise a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 17, the figure illustrates a block diagram of an example UE 1760. UE 1760 may comprise a smart phone, a wireless tablet, a laptop computer with wireless capability, a wearable device, a machine device that may facilitate vehicle telematics, and the like. UE 1760 comprises a first processor 1730, a second processor 1732, and a shared memory 1734. UE 1760 includes radio front end circuitry 1762, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1762 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 17, UE 1760 may also include a SIM 1764, or a SIM profile, which may comprise information stored in a memory (memory 1734 or a separate memory portion), for facilitating wireless communication with RAN 105 or core network 130 shown in FIG. 1. FIG. 17 shows SIM 1764 as a single component in the shape of a conventional SIM card, but it will be appreciated that SIM 1764 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1764 and another device, which may be a component of RAN 105 or core network 130 shown in FIG. 1). A SIM profile 1764 may also comprise identifying information that is unique to the SIM, or SIM profile, such as, for example, an International Mobile Subscriber Identity (“IMSI”) or information that may make up an IMSI.

SIM 1764 is shown coupled to both the first processor portion 1730 and the second processor portion 1732. Such an implementation may provide an advantage that first processor portion 1730 may not need to request or receive information or data from SIM 1764 that second processor 1732 may request, thus eliminating the use of the first processor acting as a ‘go-between’ when the second processor uses information from the SIM in performing its functions and in executing applications. First processor 1730, which may be a modem processor or baseband processor, is shown smaller than processor 1732, which may be a more sophisticated application processor, to visually indicate the relative levels of sophistication (i.e., processing capability and performance) and corresponding relative levels of operating power consumption levels between the two processor portions. Keeping the second processor portion 1732 asleep/inactive/in a low power state when UE 1760 does not need it for executing applications and processing data related to an application provides an advantage of reducing power consumption when the UE only needs to use the first processor portion 1730 while in listening mode for monitoring routine configured bearer management and mobility management/maintenance procedures, or for monitoring search spaces that the UE has been configured to monitor while the second processor portion remains inactive/asleep.

UE 1760 may also include sensors 1766, such as, for example, temperature sensors, accelerometers, gyroscopes, barometers, moisture sensors, and the like that may provide signals to the first processor 1730 or second processor 1732. Output devices 1768 may comprise, for example, one or more visual displays (e.g., computer monitors, VR appliances, and the like), acoustic transducers, such as speakers or microphones, vibration components, and the like. Output devices 1768 may comprise software that interfaces with output devices, for example, visual displays, speakers, microphones, touch sensation devices, smell or taste devices, and the like, that are external to UE 1760.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one user equipment comprising at least one processor from a radio network node, at least one bearer congestion report indicative of at least one congestion management indication corresponding to at least one determined congestion corresponding to at least one bearer being used by the at least one user equipment to communicate traffic with the radio network node; and
responsive to the at least one bearer congestion report, communicating traffic with respect to the radio network node based on the at least one congestion management indication.

2. The method of claim 1, wherein the at least one congestion management indication is indicative of at least one of: at least one delay corresponding to the at least one bearer or at least one data rate corresponding to the at least one bearer.

3. The method of claim 1, wherein the at least one congestion management indication is further indicative of at least one bearer quality switching indication indicative that a first quality corresponding to the at least one bearer is to be changed, by the radio network node, to a second quality corresponding to the at least one bearer, and wherein, based on the at least one determined congestion, the second quality is capable of facilitating delivery of uplink traffic from the at least one user equipment to the radio network node according to a quality-of-service associated with at least one traffic flow being facilitated by the at least one bearer.

4. The method of claim 3, further comprising avoiding, by the at least one user equipment, determining, based on the at least one congestion management indication, at least one processing quality to apply to traffic corresponding to the at least one traffic flow.

5. The method of claim 3, wherein the at least one congestion management indication is a first congestion management indication, wherein the first congestion management indication is indicative of at least one of: at least one delay corresponding to the at least one bearer or at least one data rate corresponding to the at least one bearer, and wherein the method further comprises:
training, with the at least one delay or the at least one data rate, at least one learning model to result in at least one trained learning model, wherein the at least one trained learning model is to be usable by the at least one user equipment to, based on a second congestion management indication, determine at least one processing quality to apply to traffic corresponding to the at least one traffic flow being delivered via the at least one bearer.

6. The method of claim 1, further comprising:
based on the at least one congestion management indication, determining, by the at least one user equipment, at least one processing quality to apply to traffic corresponding to at least one traffic flow being delivered via the at least one bearer.

7. The method of claim 6, wherein the at least one processing quality corresponds to at least one encoder and decoder (CODEC).

8. The method of claim 7, wherein the at least one traffic flow being delivered via the at least one bearer is being delivered according to a first CODEC, wherein the at least one CODEC that corresponds to the at least one processing quality is a second CODEC, and wherein the method further comprises:
delivering, by the at least one user equipment to the radio network node, the at least one traffic flow via the at least one bearer according to the second CODEC.

9. The method of claim 8, wherein the determining of the at least one processing quality to apply to the traffic corresponding to the at least one traffic flow comprises:
analyzing, with respect to at least one delay specification corresponding to the second CODEC or at least one data rate specification corresponding to the second CODEC, at least one of at least one delay associated with the at least one traffic flow or at least one data rate associated with the at least one traffic flow.

10. The method of claim 8, further comprising:
determining, by the at least one user equipment, at least one modulation scheme or at least one coding scheme that is capable of facilitating transmitting, by the at last one user equipment to the radio network node, the traffic according to the second CODEC to result in at least one determined modulation scheme or at least one determined coding scheme.

11. The method of claim 10, further comprising:
transmitting, by the at least one user equipment to the radio network node, at least one modulation and coding scheme report indicative of the at least one determined modulation scheme or the at least one determined coding scheme, wherein the at least one determined modulation scheme or the at least one determined coding scheme is to be usable by the radio network node to decode the traffic.

12. A user equipment, comprising at least one processor configured to process executable instructions that, when executed by the at least one processor, facilitate performance of operations, comprising:
receiving, from a radio network node, a bearer congestion report indicative of at least one determined congestion, determined by the radio network node, corresponding to a bearer being used by the user equipment to transmit traffic, associated with a traffic flow, to the radio network node; and
based on the at least one determined congestion, transmitting the traffic to the radio network node.

13. The user equipment of claim 12, wherein the operations further comprise:
based on the at least one determined congestion, determining at least one processing quality to apply to transmission of the traffic, via the bearer, to result in at least one determined processing quality; and
responsive to the bearer congestion report, transmitting the traffic to the radio network node according to the at least one determined processing quality.

14. The user equipment of claim 13, wherein the at least one processing quality corresponds to at least one encoder and decoder (CODEC).

15. The user equipment of claim 14, wherein, before the receiving of the bearer congestion report, the traffic flow is delivered according to a first CODEC, wherein the at least one CODEC that corresponds to the at least one determined processing quality is a second CODEC, and wherein the transmitting the traffic according to the at least one determined processing quality comprises transmitting the traffic according to the second CODEC.

16. The user equipment of claim 12, wherein the operations further comprise:
transmitting, to the radio network node, at least one modulation and coding scheme report indicative of at least one modulation scheme or at least one coding scheme to be usable by the radio network node to decode the traffic transmitted according to the second CODEC.

17. A non-transitory machine-readable medium, comprising executable instructions that, when executed by at least one processor of a user device, facilitate performance of operations, comprising:
receiving, from at least one radio network equipment component, a bearer congestion report indicative of at least one congestion indication corresponding to at least one determined congestion, determined by the at least one radio network equipment component, and corresponding to a bearer being used by the user device to transmit traffic, associated with a traffic flow, to the at least one radio network equipment component; and
based on the at least one congestion indication, transmitting the traffic to the at least one radio network equipment component.

18. The non-transitory machine-readable medium of claim 17, wherein the at least one congestion indication is indicative of at least one bearer quality switching indication indicative that a first quality corresponding to the bearer is to be changed, by the at least one radio network equipment component, to a second quality corresponding to the bearer, and wherein, based on the at least one determined congestion, the second quality is capable of facilitating delivery of uplink traffic from the user device to the at least one radio network equipment component according to a quality-of-service associated with the traffic flow being facilitated by the bearer.

19. The non-transitory machine-readable medium of claim 17, wherein the operations further comprise:
based on the at least one congestion indication, determining at least one encoder and decoder (CODEC) to apply to the transmitting the traffic, via the bearer, to result in at least one determined CODEC, wherein the transmitting of the traffic to the at least one radio network equipment component comprises transmitting the traffic according to the at least one determined CODEC.

20. The non-transitory machine-readable medium of claim 19, wherein the operations further comprise:
transmitting, to the at least one radio network equipment component, at least one modulation and coding scheme report indicative of at least one modulation scheme or at least one coding scheme to be usable by the at least one radio network equipment component to decode the traffic transmitted according to the at least one determined CODEC.
